(19) United States
(12) Patent Application Publication
(10) Pub. No.: US 2002/0068495 A1
(43) Pub. Date: Jun. 6, 2002

(54) Three dimensional ultramicrocellular fiber batt

(76) Inventors: Arun Pal Aneja, Greenville, NC (US); Jeffrey David Cohen, Kennett Square, PA (US); Hsiang Shih, Wilmington, DE (US); Hyunkook Shin, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/969,257

(22) Filed: Oct. 2, 2001

Related U.S. Application Data
(60) Provisional application No. 60/238,357, filed on Oct. 6, 2000.

(51) Int. Cl. B32B 5/02; B32B 27/04

(52) U.S. Cl. 442/339; 442/149

(57) ABSTRACT

The present invention relates to a three dimensional batt comprising at least 70 vol. % randomly-oriented ultramicrocellular fibers mutually adhered with a thermoset adhesive binder.

In another embodiment, the present invention relates to a compression molded midsole for a shoe comprising a three dimensional batt of randomly-oriented ultramicrocellular fibers, wherein at least some of the fibers extend throughout the thickness direction of said batt.

### FIELD OF THE INVENTION

This invention relates to novel, three-dimensional (3-D) structures incorporating ultramicrocellular (UMC) fibers and to uses of such structures.

### BACKGROUND OF THE INVENTION

Crystalline polymeric UMC structures and methods for their production are described in U.S. Pat. No. 3,227,664. The UMC structures are particularly unique owing to the polyhedral-shaped structure of their cells, to the film-like character of their cell walls, and to the uniform texture and high degree of molecular orientation, i.e. uniplanar orientation, existing in those walls. Together these features serve to define a class of materials which, in comparison with prior art cellular structures, exhibit outstanding strength and resiliency properties although fabricated at extremely low densities. From the standpoint of still other desirable characteristics, the UMC structures are supple, opaque, pneumatic and have an exceedingly high bulk and low thermal conductivity. Because of this superior combination of properties and the fact that they can be produced in sheet, filament or other shaped or bulk form, the UMC structures are well adapted to a great variety of end uses.

In the past UMC fibers were laid down in relatively thin layers so as to form, for example carpet underlay. However, in order to obtain a batt with firm cushioning capability it was necessary to compact the batt to such an extent that the volume-fraction occupied by the microcellular filamentary material was greater than 0.4 but less than 1.0, such that the batt was an essentially two dimensional (2-D), planar structure. In order to obtain thicker batts, having densities suitable for use as midsoles for athletic shoes, several layers of the 2-D batts were superimposed, with adhesive between the batt layers (Technical Services Report no. PR-8801, SATRA Footwear Technology Centre, Jun. 5, 1987). Unfortunately, such constructions, while demonstrating enhanced resiliency to forces applied in the thickness direction, were found to be undesirable, since they offered little resistance to delamination when subjected to repeated dynamic forces lateral to the thickness direction.

Several prior art references suggest batts of microcellular fibers incorporating thermoplastic adhesive binders, including U.S. Pat. Nos. 3,227,664 and 3,535,181. However, neither of these references disclose or suggest the use of thermoset adhesive binders, nor the use of UMC fiber batts as midsoles for shoes.

U.S. Pat. No. 3,503,840 discloses composite cellular cushioning structures having a resilient open-celled polymeric foam matrix with closed-cell gas-inflated polymeric cellular reinforcing particles disposed therein. The foam matrix may be selected from polyester and polyether urethanes. However, U.S. Pat. No. 3,503,840 fails to disclose or suggest non-foamed matrices and the use of the composites as midsoles for shoes.

U.S. Pat. No. 3,637,458 discloses a method of making low density foams of inflated microcells having improved work-to-break and work-to-tear properties, and suggests that such foams can be used for a number of cushioning applications, including athletic padding and shoe lining. However, U.S. Pat. No. 3,637,458 contains no suggestion of creating a batt of individual ultramicrocellular fibers mutually adhered with a binder.

It would be advantageous to develop UMC fiber-containing batts having sufficient thickness to provide enhanced resiliency to forces applied in the thickness direction, combined with improved resistance to mechanical deterioration due to forces applied in the direction lateral to the thickness direction.

### SUMMARY OF THE INVENTION

The present inventors have discovered a method of making a three dimensional batt of UMC fibers, which has enhanced resiliency in both the thickness and lateral directions.

In a first embodiment, the present invention relates to a three-dimensional batt comprising at least 70 vol. % randomly-oriented ultramicrocellular (UMC) fibers mutually adhered with a thermoset adhesive binder.

In another embodiment, the present invention relates to a resilient padding made of a three dimensional batt comprising at least 70 vol. % randomly-oriented UMC fibers mutually adhered with a thermoset adhesive binder.

In a further embodiment, the present invention relates to a midsole for a shoe comprising a compression molded three dimensional batt of randomly oriented ultramicrocellular (UMC) fibers, wherein at least some of said UMC fibers extend throughout the thickness direction of said batt.

### DETAILED DESCRIPTION OF THE INVENTION

The present inventors have discovered that UMC fibers can be compression molded in the presence of thermosetting adhesive binders, into a 3-D batt having a significant proportion of UMC fibers disposed in the thickness direction of the batt, so as to provide enhanced resistance to delamination upon repeated application of dynamic forces in directions lateral to the thickness direction.

The three dimensional batts of the present invention incorporate UMC fibers which are disposed in all of the x-, y-, and z-directions, wherein the x- and y-directions are defined as being mutually perpendicular directions in the same plane (the x/y plane), and the z-direction is perpendicular to both the x- and y-directions. That is, if the x/y plane is oriented horizontally, the z-direction is vertical. In the present invention, the x/y plane defines the length and width of the batt and the z-direction the thickness of the batt.

According to the present invention, at least 70 vol. %, and up to 99 vol. % of randomly-oriented UMC fibers are disposed within the batt, having at least some UMC fibers extending throughout the thickness of the batt, wherein said fibers are adhered with a thermoset polymer adhesive. Preferably, the fiber batts of the present invention contain at least 85 vol. % of UMC fibers, more preferably at least 92 vol. % of UMC fibers. It is preferable to minimize the amount of binder used so as to rely primarily on the performance characteristics of the UMC fibers themselves. Accordingly, with a suitably strong adhesive binder, up to 99 vol. % of UMC fibers can be used in the 3-D batts of the invention. The volume percent measurements above are intended to express the volume of UMC fibers after compression molding of the UMC fibers and binder in the batt.

Due to the extremely low density of the UMC fibers (approximately 0.06 g/cc after compression molding), the weight ratio of thermoset binder in the fiber batt can be as much as about 300%, based on the weight of the UMC fibers (a 3:1 weight ratio of binder/fibers), preferably less than about 150%, based on the weight of the fibers.

The randomly-oriented UMC fibers within the 3-D batt include at least some UMC fibers which extend throughout the thickness of the batt, i.e. from top to bottom. The combination of thickness-oriented fibers and the thermoset polymer adhesive provide enhanced cohesiveness and therefore strength to the batt, such that when it is subjected to dynamic forces in the general direction of the x/y plane, that is, lateral to the thickness direction, it resists delamination or other such structural deterioration. Either continuous or non-continuous fibers can be used in the present invention. In the case of non-continuous fibers, those generally described as “staple” fibers are preferred, i.e. having lengths from about 0.5 to 6 inches, preferably from about 1 to 2 inches.

The UMC fibers used for making the batt of the present invention are formed by flash spinning a thermoplastic polymer, preferably a non-elastomeric thermoplastic polymer, which more preferably has a significant level of crystallinity. Methods of forming UMC fibers useful in the present invention are disclosed in one or more of the following U.S. Pat. Nos. 3,227,664; 3,227,784; 3,375,211; 3,375,212; and 3,381,077, which are incorporated by reference herein in their entireties.

A wide variety of both addition and condensation polymers can form UMC fibers with the essential characteristics. Typical of such polymers are: polyhydrocarbons such as polyethylene, polypropylene and polystyrene; polyethers such as polyformaldehyde; vinyl polymers such as polyvinyl chloride and polyvinylidene fluoride; polyamides such as polycaprolactam and polyhexamethylene adipamide; polyurethanes such as the polymer from ethylene bischloroformate and ethylene diamine; polyesters such as polyhydroxypivalic acid and poly(ethylene terephthalate); copolymers such as poly(ethylene terephthalate-isophthalate) and their equivalents. Preferred materials are polyesters, including poly(ethylene terephthalate), poly(propylene terephthalate), poly(butylene terephthalate), poly(1,4-cyclohexylene-dimethylene terephthalate) and copolymers thereof. Most or all of the polymers useful as fiber materials according to the present invention can be derived from recycled materials.

As described in U.S. Pat. Nos. 3,375,211 and 3,375,212, there are generally two methods for introducing an inflatant into the UMC fibers. One method, which is now commonly referred to as the “post inflation” method, generally involves treating the previously formed polymeric fibers with a plasticizing agent which plasticizes, i.e. swells, the cell walls, and a specific inflatant. The plasticizing agent is then quickly removed leaving the inflatant trapped within the cells. When the cells are subsequently exposed to air, an osmotic pressure gradient forms allowing air to penetrate and inflate the cells, while the inflatant remains substantially trapped within the cells.

Another method, which is now commonly referred to as the “spun-in inflation” method, is a flash spinning procedure which generally involves mixing the polymer, inflatant, and a spin agent in a pressure vessel to form a spinnable solution. The solution is then extruded through an orifice into a region of substantially lower pressure and temperature to form the polymeric fibers.

Suitable inflatants must have certain minimum properties.

(a) The inflatant must be substantially “impermeant”, meaning that the inflatant's permeability coefficient for diffusion through the cell walls is not only less than air at 25° C., but that the inflatant is also incapable of permeating the same cell walls at room temperature, e.g. below 40° C., at such a rate that 50% or more of the inflatant will diffuse into an air atmosphere within one day's time, preferably one month's time or longer.

(b) The inflatant must be capable of generating a vapor pressure of at least 30 mm Hg at a temperature below the softening point of the polymer.

(c) Since the rate of permeation of the inflatant increases as its diffusivity and solubility increase, the inflatant should have as large a molecular size as possible, consistent with the 30 mm Hg minimum vapor pressure, and should have substantially no solvent power or affinity for the confining polymer cell walls.

U.S. Pat. No. 5,254,400, incorporated herein in its entirety, discloses a number of hydrofluorocarbon inflatants which meet the minimum properties expressed above. Suitable inflatants include pentafluoroethane and heptafluoropropane. While it is known to use other inflatants, such as chlorofluorocarbons (CFC's), hydrochlorofluorocarbons (HCFC's), sulfur hexafluoride, perfluorocyclobutane or the like, the hydrofluorocarbons of U.S. Pat. No. 5,254,400 are preferred as being more environmentally “friendly”, as described therein.

The impermeant inflatant permeates through the cell walls so slowly that it is substantially permanently retained within the foam cells, regardless of the frequency or duration of compressive loading. The presence of impermeant inflatant within the cells creates an osmotic gradient favoring inward permeation of air. Thus, on exposure to air, equilibrium is established wherein the partial pressure of air in the cells becomes essentially atmospheric and the total internal pressure within the cells becomes superatmospheric, due to the additional pressure of the inflatant gas within the cell. This produces full inflation of the closed cells. Moreover, even if some air is lost during compressive loading, impermeant inflatant remains in the cell and the resulting osmotic pressure gradient causes spontaneous recovery of both volume and pneumaticity of the foam structure when the compressive load is removed, due to inward permeation of air.

The thermoset binder polymers of the present invention can be any such materials which would provide adequate adhesion between the UMC fibers so as to resist or prevent mechanical deterioration of the 3-D batt upon application of dynamic forces lateral to the thickness direction of the batt. Those skilled in the art will recognize that the choice of binder may depend upon the nature of the polymer selected for the UMC fibers. For example, when using UMC fibers formed of poly(ethylene terephthalate), a good choice of binder is a linear aliphatic polyester urethane, crosslinked with an aliphatic polyisocyanate.

Since the 3-D batts of the present invention are resistant to delamination under dynamic forces applied in directions lateral to the thickness direction of the batt, they are particularly advantageous when used to form midsoles for shoes, especially athletic shoes, which are subject to repeated application of lateral forces. Shoe midsoles formed from the inventive 3-D batts have been found to provide great improvements in performance characteristics over conventional midsoles, such as resilience to repeated forces applied in the thickness direction of the batt, cushioning, energy return and penetration resistance, and are much lighter than conventional midsoles formed from, for example, ethylvinyl acetate foam or those incorporating air bladders.

### EXAMPLE

The UMC midsole is prepared in four basic steps, 1) preparation of binder solution, 2) application of binder to UMC fibers, 3) transfer of fiber to the mold, and 4) curing which was carried out in two sub-steps. A mold of an athletic shoe was used for the shaping of UMC foam midsoles. The volume of the midsole of this mold is 345 ml per sole. For ease of releasing, all mold surfaces were coated with polytetrafluoroethylene.

The binder solution used for the preparation of the athletic shoe midsole of this example was prepared from the following ingredients:

100 parts (3410 g) of linear aliphatic polyester urethane;

5 parts (171 g) of aliphatic polyisocyanate; and

20 parts (682 gm) water.

The solution was added to a 4-liter beaker and mixed for 30 minutes before use.

A total of 10 g poly(ethylene terephthalate) UMC fiber is used per midsole, left or right. The fiber is added in three parts. First, 4 g UMC fibers were placed into a perforated stainless basket, 6″ diameter×6″ height, completely immersed in the binder solution, lifted from the solution, and drained for at least 5 minutes to remove excess binder solution.

The fiber was transferred into the cavity of the left mold and distributed in varying thickness according to the sloped shape of the mold. More fiber was placed in area of deeper depth. This step was repeated for the right mold. The top of the mold was closed, leaving a gap of ⅛″ between the top and the bottom of the mold for easy venting of water vapor from the binder solution. The fiber in mold was pre-cured for 15 minutes at 160° C. with a press. The pre-cured UMC foam pad was loose, tacky, but dry, ideal for further curing to stabilize the structure. The above step was repeated to prepare a second part that is identical to the first part.

Preparation of the third part of the midsole is as follows. Binder solution was applied to 2 g of UMC fiber using the procedure described above and the fiber was placed into a flat mold for pre-curing (15 minutes at 160° C.) into a slab of 3″×13″×20 mm size.

The two left pre-cured midsoles, i.e., first and second parts, were stacked to form the preform of the left midsole. The third part of the pre-cured UMC foam pad was sliced into 2 equal width strips and wrapped around the pre-cured left midsole preform. The entire assembly was placed into the left midsole cavity of the shoe mold and cured for 55 minutes at 160° C. The right side midsole was similarly prepared at the same time. (The part three UMC pad was used primarily to enhance the detail of the midsole around the edges, and contributed little to the mechanical performance of the midsoles). The volume percent of UMC fibers in the midsole is calculated to be about 92 vol. %.

The final cured midsoles weighed 25.9 g and 26.9 g for the left and right soles, respectively. These correspond to midsole foam densities of 0.075 g/cc and 0.078 g/cc for the left and right soles, respectively. The binder contents were 61 wt. % and 63 wt. % in the left and right soles, respectively. The midsoles were then ready for converting into athletic shoes and for performance testing.

Those skilled in the art will recognize that the 3-D UMC fiber batts of the present invention are suitable in many other cushioning-type uses, for example as protective padding for athletic gear, such as football or hockey pads, and perhaps for headgear, such as bicycle or motorcycle helmets.

What is claimed is:

1. A three dimensional batt comprising at least 70 vol. % randomly-oriented ultramicrocellular (UMC) fibers mutually adhered with a thermoset adhesive binder.

2. The three dimensional batt of claim 1, wherein at least some of said UMC fibers extend throughout a thickness direction of said batt.

3. The three dimensional batt of claim 2, wherein said batt is resistant to delamination under dynamic forces applied in directions lateral to the thickness direction.

4. The three dimensional batt of claim 1, wherein said UMC fibers comprise an inflatant gas encapsulated in cells of non-elastomeric thermoplastic polymer.

5. The three dimensional batt of claim 4, wherein said thermoplastic polymer comprises one or more of polyhydrocarbons, polyethers, vinyl polymers, polyamides, polyurethanes, polyesters and their copolymers.

6. The three dimensional batt of claim 5, wherein said thermoplastic polymer is a polyester selected from the group consisting of poly(ethylene terephthalate), poly(propylene terephthalate), poly(butylene terephthalate), poly(1,4-cyclohexylene-dimethylene terephthalate) and copolymers thereof.

7. The three dimensional batt of claim 4, wherein said inflatant gas comprises a hydrofluorocarbon.

8. The three dimensional batt of claim 1, wherein the amount of said binder is less than about 300% based on the weight of the UMC fibers.

9. The three dimensional batt of claim 1, wherein said binder comprises a linear aliphatic polyester urethane crosslinked with an aliphatic polyisocyanate.

10. A midsole for a shoe comprising a compression molded three dimensional batt of randomly-oriented ultramicrocellular (UMC) fibers, wherein at least some of said UMC fibers extend throughout the thickness direction of said batt.

11. The midsole of claim 10, wherein said UMC fibers are mutually adhered with a thermoset adhesive binder.

12. The midsole of claim 10, wherein at least some of said UMC fibers extend throughout the thickness direction of said midsole.

13. A shoe comprising a midsole comprising a compression molded three dimensional batt of randomly-oriented ultramicrocellular (UMC) fibers, wherein at least some of said UMC fibers extend throughout the thickness direction of said batt.

14. The shoe of claim 13, wherein at least some of said UMC fibers extend throughout the thickness direction of said midsole.

15. A resilient padding made of a three dimensional batt comprising at least 70 vol. % randomly-oriented UMC fibers mutually adhered with a thermoset adhesive binder.
